(19) United States
(12) Patent Application Publication
(10) Pub. No.: US 2026/0211366 A1
(43) Pub. Date: Jul. 23, 2026

(54) IMAGE FORMING APPARATUS

(71) Applicant: CANON KABUSHIKI KAISHA, Tokyo (JP)

(72) Inventors: TOMOFUMI SAKUMA, Ibaraki (JP); HARUHIKO NAKATSU, Ibaraki (JP)

(21) Appl. No.: 19/437,951

(22) Filed: Dec. 31, 2025

(30) Foreign Application Priority Data
Jan. 21, 2025 (JP) 2025-008705

(51) Int. Cl. G03G 21/16; G03G 15/00

(52) U.S. Cl. CPC G03G 21/1619; G03G 15/6511

(57) ABSTRACT

Provided is an image forming apparatus including: a plurality of sheet cassettes; and a frame body, in which the frame body includes a front frame portion including a first strut extending in a vertical direction, a second strut extending in the vertical direction, a first beam extending in a first direction intersecting the vertical direction and connecting the first strut and the second strut, and a second beam extending in the first direction and connecting the first strut and the second strut, and a stay connected to the first beam and the second beam and extending in the vertical direction between the first strut and the second strut, and the stay is detachable from the first beam and the second beam, without disassembling the front frame portion.

### BACKGROUND

### Field of the Technology

The present disclosure relates to an image forming apparatus, such as a copying machine or a printer using an electrophotographic system or an electrostatic recording system.

### Description of the Related Art

Conventionally, a frame body of an image forming apparatus joined by welding has been proposed. Japanese Patent Application Laid-Open No. 2006-137593 discusses an image forming apparatus including a plurality of sheet cassettes capable of accommodating large-sized and small-sized sheets.

However, in such image forming apparatus, since the frame body is joined by welding, it is necessary to prepare a product including a sheet cassette that accommodates large-sized sheet and a product including a sheet cassette that accommodates small-sized sheet. Therefore, in such frame body, since it is necessary to prepare a dedicated frame body for each model according to the size and arrangement of the sheet cassette to be used, management at a production site becomes complicated and reuse of the frame body is limited.

### SUMMARY

An aspect of the present disclosure provides an image forming apparatus that includes a plurality of sheet cassettes, each sheet cassette of the plurality of sheet cassettes configured to store at least one sheet; and a frame body configured to support the plurality of sheet cassettes. The frame body includes a front frame portion and a stay member. The front frame portion includes a first strut extending in a vertical direction, a second strut extending in the vertical direction, a first beam extending in a first direction intersecting the vertical direction and connecting the first strut and the second strut, and a second beam extending in the first direction and connecting the first strut and the second strut. The stay is connected to the first beam and the second beam, extending in the vertical direction between the first strut and the second strut. The plurality of sheet cassettes includes a first sheet cassette and a second sheet cassette. The first sheet cassette is supported on a first side of the stay in the first direction, and the second sheet cassette is supported on a second side of the stay in the first direction. The stay is detachable from the first beam and the second beam, without disassembling the front frame portion.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of a first configuration of an image forming apparatus according to an embodiment of the present disclosure;

FIG. 2 is a schematic diagram of a second configuration of the image forming apparatus according to the present disclosure;

FIG. 3 is a schematic diagram of a third configuration of the image forming apparatus according to the present disclosure;

FIG. 4 is a perspective view of a part of a frame body of the image forming apparatus according to the present disclosure, viewed from the front right upper side;

FIG. 5 is a perspective view of a part of the frame body of the image forming apparatus according to the present disclosure, viewed from the rear right upper side;

FIG. 6 is an exploded perspective view of a part of the frame body of the image forming apparatus according to the present disclosure;

FIGS. 7A, 7B, 7C, and FIG. 7D are schematic views of a first configuration and a second configuration of the image forming apparatus according to the present disclosure and a schematic view of a frame body thereof;

FIGS. 8A and 8B are perspective views of a lower frame and a part of the lower frame of the frame body of the image forming apparatus according to the present disclosure, viewed from the front right upper side;

FIG. 9 is an exploded perspective view of the lower frame of the frame body of the image forming apparatus according to the present disclosure;

FIGS. 10A and 10B are enlarged exploded perspective views of a part of the lower frame of the frame body of the image forming apparatus according to the present disclosure;

FIGS. 11A, 11B, and FIG. 11C are an enlarged perspective view and a side view of a part of the lower frame of the frame body of the image forming apparatus according to the present disclosure;

FIGS. 12A and 12B are diagrams illustrating a configuration of a central stay unit of the frame body of the image forming apparatus according to the present disclosure; and

FIGS. 13A and 13B are perspective views of a central stay unit and a small-size cassette of a frame body of the image forming apparatus according to the present disclosure.

### DESCRIPTION OF THE EMBODIMENTS

Hereinafter, embodiments will be described in detail with reference to the drawings.

### First Configuration of Image Forming Apparatus

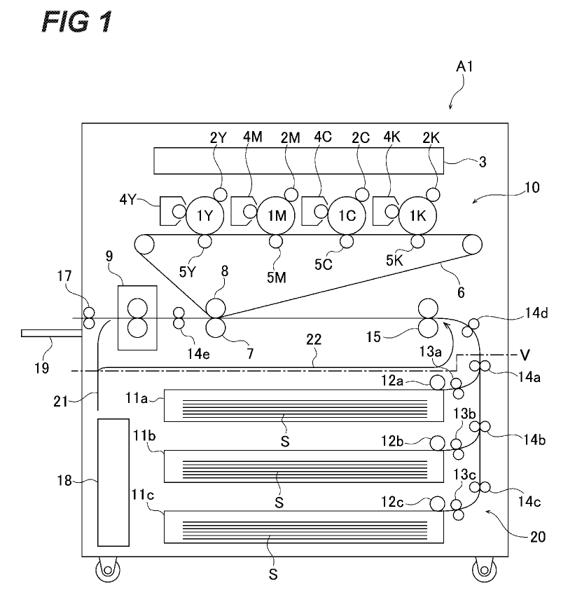

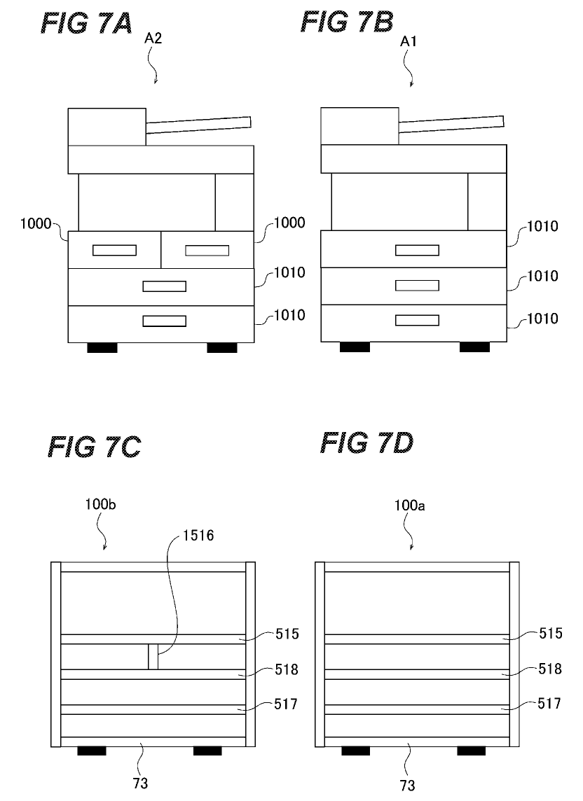

A configuration of a first configuration of an image forming apparatus A1 according to an embodiment of the present disclosure will be described in detail with reference to FIGS. 1 and 7B.

FIG. 7B is a schematic front view of an external appearance of the image forming apparatus A1.

Here, the image forming apparatus A1 exemplifies an intermediate tandem type image forming apparatus that transfers toners of four colors of yellow Y, magenta M, cyan C, and black K to an intermediate transfer belt to form an image, and then transfers the image from the intermediate transfer belt to a sheet to form an image.

Specifically, the image forming apparatus A1 includes a fixing device 9, an image forming unit 10, and pairs of conveying rollers 14a, 14b, 14c, 14d, and 14e. The image forming apparatus A1 includes a pair of registration rollers 15, a pair of discharge rollers 17, a recovery toner container 18, a discharge tray 19, a feeding unit 20, a reverse conveying portion 21, and a duplex conveying portion 22.

The fixing device 9 heats and pressurizes a sheet S conveyed by the pair of conveying rollers 14e to fix the toner image on the sheet S. The fixing device 9 conveys the sheet S on which the toner image is fixed only on one side when the image is formed on only one side or the sheet S on which the toner image is fixed on both sides when the image is formed on both sides to the pair of discharge rollers 17. In a case where an image is formed on both sides, the fixing device 9 conveys the sheet S on which the toner image is fixed only on one side to the reverse conveying portion 21.

The image forming unit 10 is supported by a frame body 100a (FIG. 7D) to be described later. The image forming unit 10 forms an image on the sheet S fed by the feeding unit 20, and conveys the sheet S on which the image is formed to the pair of conveying rollers 14e. The image forming unit 10 includes photosensitive drums 1Y, 1M, 1C, and 1K, charging rollers 2Y, 2M, 2C, and 2K, a laser scanner unit 3, and developing devices 4Y, 4M, 4C, and 4K. The image forming unit 10 includes primary transfer rollers 5Y, 5M, 5C, and 5K, an intermediate transfer belt 6, a secondary transfer roller 7, and a secondary transfer counter roller 8.

After being uniformly charged by the charging rollers 2Y, 2M, 2C, and 2K, the photosensitive drums 1Y, 1M, 1C, and 1K are irradiated with laser light by the laser scanner unit 3, whereby electrostatic latent images are formed. Toners are attached to the electrostatic latent images formed by the laser scanner unit 3 by the developing devices 4Y, 4M, 4C, and 4K, whereby toner images are formed on the photosensitive drums 1Y, 1M, 1C, and 1K.

The charging rollers 2Y, 2M, 2C, and 2K charge the surfaces of the photosensitive drums 1Y, 1M, 1C, and 1K.

The laser scanner unit 3 receives image data transmitted from an external device. The laser scanner unit 3 irradiates the surfaces of the photosensitive drums 1Y, 1M, 1C, and 1K charged by the charging rollers 2Y, 2M, 2C, and 2K with laser light according to the received image data to form electrostatic latent images on the surfaces of the photosensitive drums 1Y, 1M, 1C, and 1K.

The developing device 4Y attaches yellow toner to the electrostatic latent image formed on the surface of the photosensitive drum 1Y by the laser scanner unit 3 to form a yellow toner image on the surface of the photosensitive drum 1Y.

The developing device 4M attaches magenta toner to the electrostatic latent image formed on the surface of the photosensitive drum 1M by the laser scanner unit 3 to form a magenta toner image on the surface of the photosensitive drum 1M.

The developing device 4C attaches cyan toner to the electrostatic latent image formed on the surface of the photosensitive drum 1C by the laser scanner unit 3 to form a cyan toner image on the surface of the photosensitive drum 1C.

The developing device 4K attaches a black toner to the electrostatic latent image formed on the surface of the photosensitive drum 1K by the laser scanner unit 3 to form a black toner image on the surface of the photosensitive drum 1K.

When a primary transfer bias current flows, the primary transfer roller 5Y primarily transfers the yellow toner image formed on the surface of the photosensitive drum 1Y by the developing device 4Y to the intermediate transfer belt 6.

When a primary transfer bias current flows, the primary transfer roller 5M primarily transfers the magenta toner image formed on the surface of the photosensitive drum 1M by the developing device 4M to the intermediate transfer belt 6. At this time, the primary transfer roller 5M primarily transfers the magenta toner image onto the intermediate transfer belt 6 by superimposing the magenta toner image on the yellow toner image primarily transferred onto the intermediate transfer belt 6 by the primary transfer roller 5Y.

When a primary transfer bias current flows, the primary transfer roller 5C primarily transfers the cyan toner image formed on the surface of the photosensitive drum 1C by the developing device 4C to the intermediate transfer belt 6. At this time, the primary transfer roller 5C primarily transfers the cyan toner image onto the intermediate transfer belt 6 by superimposing the cyan toner image on the magenta toner image primarily transferred onto the intermediate transfer belt 6 by the primary transfer roller 5M.

When a primary transfer bias current flows, the primary transfer roller 5K primarily transfers the black toner image formed on the surface of the photosensitive drum 1K by the developing device 4K to the intermediate transfer belt 6. At this time, the primary transfer roller 5K primarily transfers the black toner image onto the intermediate transfer belt 6 by superimposing the black toner image on the cyan toner image primarily transferred onto the intermediate transfer belt 6 by the primary transfer roller 5C.

On the intermediate transfer belt 6, toner images of respective colors are superimposed and primarily transferred by each of the primary transfer rollers 5Y, 5M, 5C, and 5K, whereby a full-color toner image is formed. The intermediate transfer belt 6 rotates to convey the full-color toner image formed by the primary transfer rollers 5Y, 5M, 5C, and 5K to the secondary transfer roller 7 and the secondary transfer counter roller 8.

The secondary transfer roller 7 and the secondary transfer counter roller 8 nip and convey the sheet S conveyed by the pair of registration rollers 15, and a secondary transfer bias current flows through the secondary transfer roller 7 to secondarily transfer the toner image conveyed by the intermediate transfer belt 6 to the sheet S. The secondary transfer roller 7 and the secondary transfer counter roller 8 convey the sheet S on which the toner image has been secondarily transferred to the pair of conveying rollers 14e.

The pair of conveying rollers 14a conveys the sheet S fed by a pair of feed rollers 13a of the feeding unit 20 or the sheet S conveyed by the pair of conveying rollers 14b to the pair of conveying rollers 14d.

The pair of conveying rollers 14b conveys the sheet S fed by a pair of feed rollers 13b of the feeding unit 20 or the sheet S conveyed by the pair of conveying rollers 14c to the pair of conveying rollers 14a.

The pair of conveying rollers 14c conveys the sheet S fed by a pair of feed rollers 13c of the feeding unit 20 to the pair of conveying rollers 14b.

The pair of conveying rollers 14d conveys the sheet S conveyed by the pair of conveying rollers 14a to the pair of registration rollers 15.

The pair of conveying rollers 14e conveys the sheet S conveyed by the secondary transfer roller 7 and the secondary transfer counter roller 8 to the fixing device 9.

The pair of registration rollers 15 corrects skew feeding of the sheet S conveyed by the pair of conveying rollers 14d or the duplex conveying portion 22, and then conveys the sheet S whose skew feeding has been corrected to the secondary transfer roller 7 and the secondary transfer counter roller 8 at a predetermined timing.

The pair of discharge rollers 17 discharges the sheet S conveyed by the fixing device 9 to the discharge tray 19.

The recovery toner container 18 recovers toner remaining on the photosensitive drums 1Y, 1M, 1C, and 1K after the primary transfer by the primary transfer rollers 5Y, 5M, 5C, and 5K and removed by a cleaning member.

The sheet S is discharged to the discharge tray 19 by the pair of discharge rollers 17.

The feeding unit 20 is supported by the frame body 100a, described with reference to FIG. 7D. The feeding unit 20 accommodates the sheet S and feeds the accommodated sheet S to the image forming unit 10. The feeding unit 20 includes a sheet cassette 11a, a sheet cassette 11b, a sheet cassette 11c, a pick-up roller 12a, a pick-up roller 12b, a pick-up roller 12c, a pair of feed rollers 13a, a pair of feed rollers 13b, and a pair of feed rollers 13c.

The sheet cassette 11a is configured to accommodate a large-sized sheet S.

The sheet cassette 11b is configured to accommodate a large-sized sheet S.

The sheet cassette 11c is configured to accommodate a large-sized sheet S.

The pick-up roller 12a picks up the sheet S stored in the sheet cassette 11a.

The pick-up roller 12b picks up the sheet S stored in the sheet cassette 11b.

The pick-up roller 12c picks up the sheet S stored in the sheet cassette 11c.

The pair of feed rollers 13a feeds the sheet S picked up by the pick-up roller 12a to the pair of conveying rollers 14a.

The pair of feed rollers 13b feeds the sheet S picked up by the pick-up roller 12b to the pair of conveying rollers 14b.

The pair of feed rollers 13c feeds the sheet S picked up by the pick-up roller 12c to the pair of conveying rollers 14c.

The reverse conveying portion 21 reverses the front and back sides and leading and trailing ends of the sheet S by switchback conveying the sheet S conveyed by the fixing device 9, and conveys the sheet S whose front and back sides and leading and trailing ends are reversed to the duplex conveying portion 22.

The duplex conveying portion 22 conveys the sheet S conveyed by the reverse conveying portion 21 to the pair of registration rollers 15.

As illustrated in FIG. 7B, the image forming apparatus A1 having the above configuration includes only a large-size cassette 1010 for accommodating the large-sized sheet S. The large-size cassette 1010 includes a sheet cassette 11a, a sheet cassette 11b, or a sheet cassette 11c.

### Second Configuration of Image Forming Apparatus

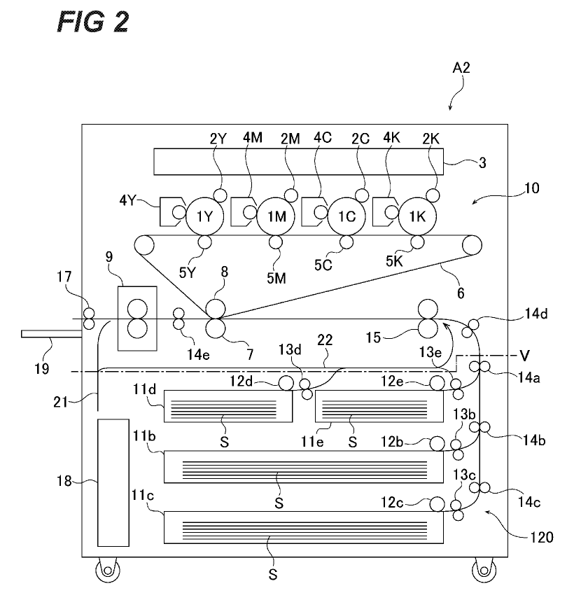

A configuration of an image forming apparatus A2 as a second configuration of an image forming apparatus according to an embodiment of the present disclosure will be described in detail with reference to FIGS. 2 and 7A.

FIG. 7A is a schematic view of a front appearance of the image forming apparatus A2.

Components in FIG. 2 that are the same as those in FIG. 1 are denoted by the same reference numerals, and the description of such components is incorporated by reference, for conciseness.

Here, the image forming apparatus A2 exemplifies an intermediate tandem type image forming apparatus that transfers toners of four colors of yellow Y, magenta M, cyan C, and black K to an intermediate transfer belt to form an image, and then transfers the image from the intermediate transfer belt to a sheet to form an image.

Specifically, the image forming apparatus A2 includes a fixing device 9, an image forming unit 10, a pair of conveying rollers 14a, a pair of conveying rollers 14b, a pair of conveying rollers 14c, a pair of conveying rollers 14d, and a pair of conveying rollers 14e. The image forming apparatus A2 includes a pair of registration rollers 15, a pair of discharge rollers 17, a recovery toner container 18, a discharge tray 19, a reverse conveying portion 21, a duplex conveying portion 22, and a feeding unit 120.

The image forming unit 10 is supported by a frame body 100b, described with reference to FIG. 7C. The image forming unit 10 forms an image on the sheet S fed by the feeding unit 120, and conveys the sheet S on which the image is formed to the pair of conveying rollers 14e.

The pair of conveying rollers 14a conveys the sheet S fed by the pair of feed rollers 13e of the feeding unit 120 or the sheet S conveyed by the pair of conveying rollers 14b to the pair of conveying rollers 14d.

The feeding unit 120 is supported by the frame body 100b, to be described later. The feeding unit 120 accommodates the sheet S and feeds the accommodated sheet S to the image forming unit 10. The feeding unit 120 includes a sheet cassette 11b, a sheet cassette 11c, a sheet cassette 11d, a sheet cassette 11e, a pick-up roller 12b, a pick-up roller 12c, a pick-up roller 12d, and a pick-up roller 12e. The feeding unit 120 includes a pair of feed rollers 13b, a pair of feed rollers 13c, a pair of feed rollers 13d, and a pair of feed rollers 13e.

The sheet cassette 11d accommodates is configured to accommodate a small-sized sheet S.

The sheet cassette 11e is configured to accommodate a small-sized sheet S.

The pick-up roller 12d picks up the sheet S stored in the sheet cassette 11d.

The pick-up roller 12e picks up the sheet S stored in the sheet cassette 11e.

The pair of feed rollers 13d feeds the sheet S picked up by the pick-up roller 12d to the duplex conveying portion 22.

The pair of feed rollers 13e feeds the sheet S picked up by the pick-up roller 12e to the pair of conveying rollers 14a.

The duplex conveying portion 22 conveys the sheet S conveyed by the reverse conveying portion 21 or the sheet S fed by the pair of feed rollers 13d to the pair of registration rollers 15.

As illustrated in FIG. 7A, the image forming apparatus A2 having the above configuration includes a large-size cassette 1010 for accommodating the large-sized sheet S and at least one small-size cassette 1000 for accommodating the small-sized sheet S. The small-size cassette 1000 includes a sheet cassette 11d and a sheet cassette 11e.

### Third Configuration of Image Forming Apparatus

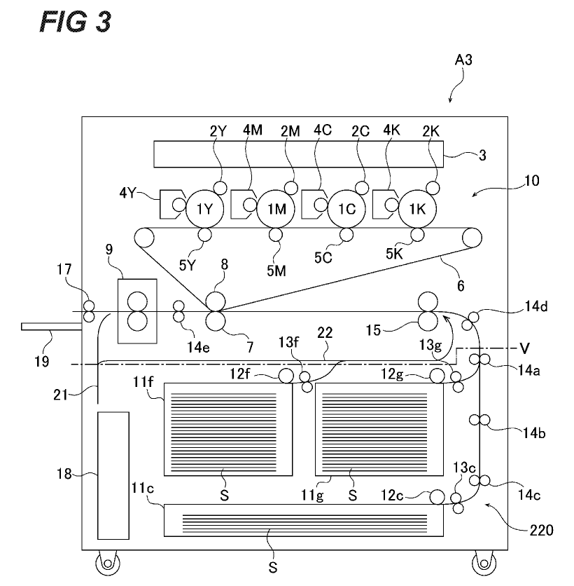

A configuration of an image forming apparatus A3 which is a third configuration of the image forming apparatus according to the first embodiment of the present disclosure will be described in detail with reference to FIG. 3.

In FIG. 3, the same components as those in FIG. 1 are denoted by the same reference numerals, and the description of such components is incorporated by reference, for conciseness.

Here, the image forming apparatus A3 exemplifies an intermediate tandem type image forming apparatus that transfers toners of four colors of yellow Y, magenta M, cyan C, and black K to an intermediate transfer belt to form an image, and then transfers the image from the intermediate transfer belt to a sheet to form an image.

Specifically, the image forming apparatus A3 includes a fixing device 9, an image forming unit 10, a pair of conveying rollers 14a, a pair of conveying rollers 14b, a pair of conveying rollers 14c, a pair of conveying rollers 14d, and a pair of conveying rollers 14e. The image forming apparatus A3 includes a pair of registration rollers 15, a pair of discharge rollers 17, a recovery toner container 18, a discharge tray 19, a reverse conveying portion 21, a duplex conveying portion 22, and a feeding unit 220.

The image forming unit 10 is supported by a frame body. The image forming unit 10 forms an image on the sheet S fed by the feeding unit 220, and conveys the sheet S on which the image is formed to the pair of conveying rollers 14e.

The pair of conveying rollers 14a conveys the sheet S fed by the pair of feed rollers 13g of the feeding unit 220 or the sheet S conveyed by the pair of conveying rollers 14b to the pair of conveying rollers 14d.

The pair of conveying rollers 14b conveys the sheet S conveyed by the pair of conveying rollers 14c to the pair of conveying rollers 14a.

The feeding unit 220 is supported by the frame body, described later. The feeding unit 220 accommodates the sheet S and feeds the accommodated sheet S to the image forming unit 10. The feeding unit 220 includes a sheet cassette 11c, a sheet cassette 11f, a sheet cassette 11g, a pick-up roller 12c, a pick-up roller 12f, a pick-up roller 12g, a pair of feed rollers 13c, a pair of feed rollers 13f, and a pair of feed rollers 13g.

The sheet cassette 11c is configured to accommodate a sheet S, including the large-sized sheet S.

The sheet cassette 11f is configured to accommodate the small-sized sheet S in a large capacity.

The sheet cassette 11g is configured to accommodate the small-sized sheet S in a large capacity.

The pick-up roller 12c picks up the sheet S stored in the sheet cassette 11c.

The pick-up roller 12f picks up the sheet S stored in the sheet cassette 11f.

The pick-up roller 12g picks up the sheet S stored in the sheet cassette 11g.

The pair of feed rollers 13c feeds the sheet S picked up by the pick-up roller 12c to the pair of conveying rollers 14c.

The pair of feed rollers 13f feeds the sheet S picked up by the pick-up roller 12f to the duplex conveying portion 22.

The pair of feed rollers 13g feeds the sheet S picked up by the pick-up roller 12g to the pair of conveying rollers 14a.

The duplex conveying portion 22 conveys the sheet S conveyed by the reverse conveying portion 21 or the sheet S fed by the pair of feed rollers 13f to the pair of registration rollers 15.

The image forming apparatus A3 having the above configuration may include a large-size cassette 1010 for accommodating the large-sized sheet S and a small-size cassette 1000 for accommodating the small-sized sheet S.

### Configuration of Frame Body of Image Forming Apparatus

Configurations of the frame body 100a of the image forming apparatus A1, the frame body 100b of the image forming apparatus A2, and the frame body of the image forming apparatus A3 according to the present disclosure will be described in detail.

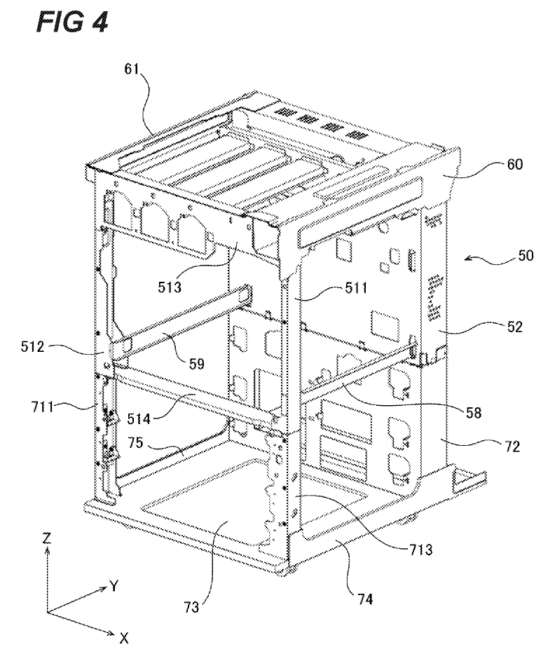

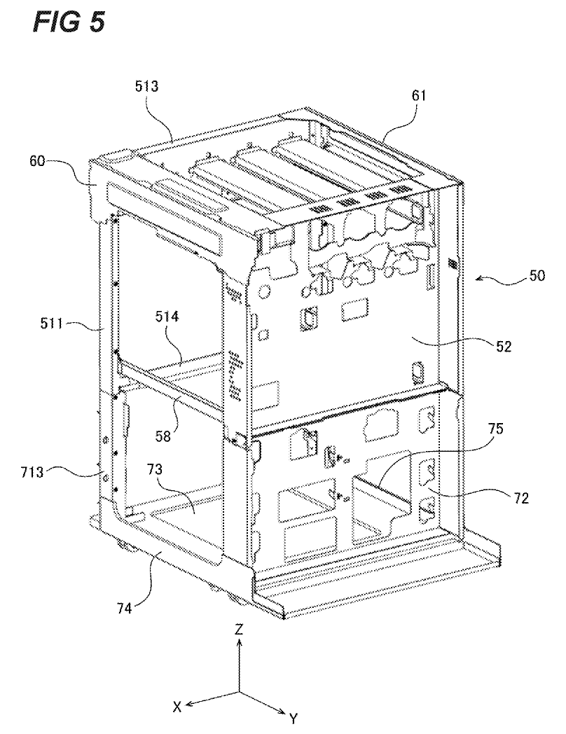

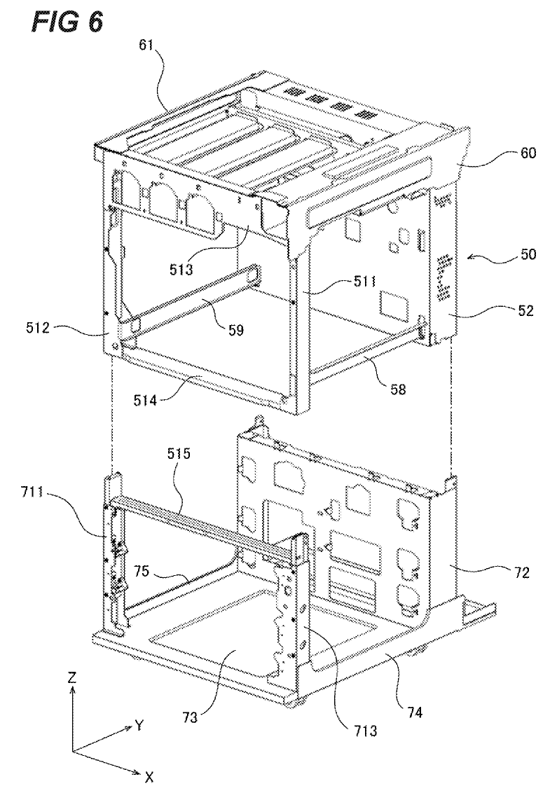

The configuration of the frame body 100a of the image forming apparatus A1 will be described in detail with reference to FIGS. 4 to 6 and FIG. 7D.

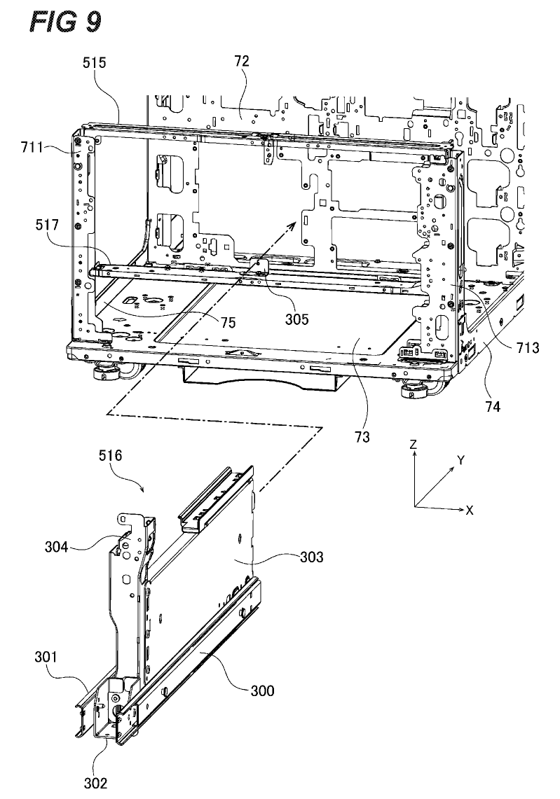

FIG. 7D is a schematic front view of the frame body 100a of the image forming apparatus A1. In FIGS. 4 to 6, a positive direction of the X axis is a right direction, a negative direction of the X axis is a left direction, a positive direction of the Y axis is a rear direction, a negative direction of the Y axis is a front direction, a positive direction of the Z axis is an upper, vertical direction, and a negative direction of the Z axis is a lower, vertical direction. The positive direction is a direction of the respective directional arrow (FIGS. 4-6 and 8A-13A), and the negative direction is a direction opposite to the direction of the arrow (FIGS. 4-6 and 8A-13A).

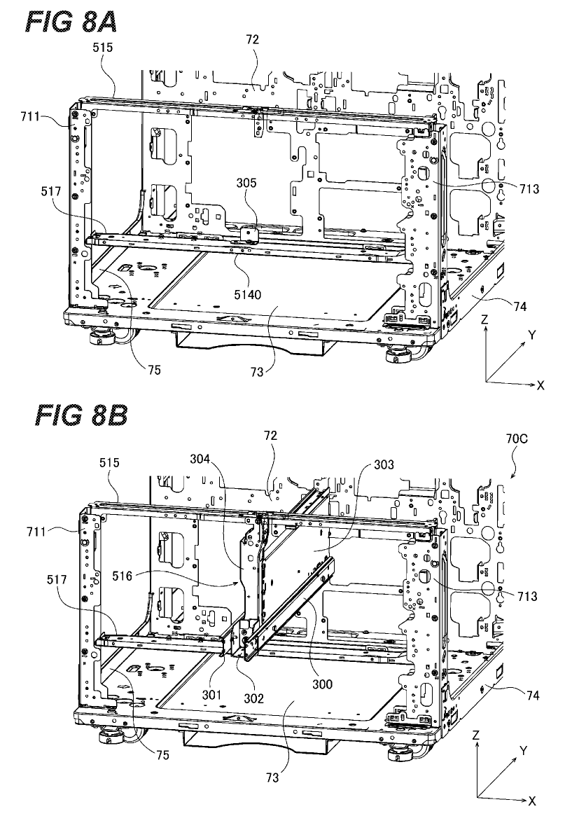

The frame body 100a supports the sheet cassette 11a, the sheet cassette 11b, and the sheet cassette 11c. The frame body 100a includes an upper frame 50 and a lower frame 70C (FIG. 8B). A dashed-dotted line V in FIGS. 1-3 indicates a boundary between the upper frame 50 and the lower frame 70C.

The upper frame 50 is formed of a metal steel plate, and is disposed above the lower frame 70C in the vertical direction. The upper frame 50 is connected to the lower frame 70C by a screw. The upper frame 50 includes an upper front frame, an upper rear side plate 52, a stay 58, a stay 59, a stay 60, and a stay 61.

The upper front frame is provided on the front side of the upper frame 50 and is formed in a rectangular frame shape. The upper front frame includes an upper right strut 511, an upper left strut 512, a stay 513, and a stay 514.

The upper right strut 511 extends in the vertical direction on the right end side of the upper front frame.

The upper left strut 512 extends in the vertical direction on the left end side of the upper front frame.

The stay 513 extends along the left-right direction on the upper end side, and connects the upper right strut 511 and the upper left strut 512. The stay 513 is welded to the upper right strut 511 and the upper left strut 512.

The stay 514 extends along the left-right direction on the lower end side, and connects the upper right strut 511 and the upper left strut 512. The stay 514 is welded to the upper right strut 511 and the upper left strut 512.

The upper rear side plate 52 is provided on the rear side (rear surface side) of the upper frame 50.

The stay 58 extends rearward from the upper front frame on the right end side and the lower end side of the upper frame 50 to connect the upper front frame and the upper rear side plate 52. The stay 58 is welded to the upper right strut 511 and the upper rear side plate 52.

The stay 59 extends rearward from the upper front frame on the left end side and the lower end side of the upper frame 50 to connect the upper front frame and the upper rear side plate 52. The stay 59 is welded to the upper left strut 512 and the upper rear side plate 52.

The stay 60 extends rearward from the upper front frame on the right end side and the upper end side of the upper frame 50 to connect the upper front frame and the upper rear side plate 52. The stay 60 is welded to the stay 513 and the upper rear side plate 52.

The stay 61 extends rearward from the upper front frame on the left end side and the upper end side of the upper frame 50 to connect the upper front frame and the upper rear side plate 52. The stay 61 is welded to the stay 513 and the upper rear side plate 52.

The lower frame 70C is formed of a metal steel plate and is disposed below the upper frame 50 in the vertical direction. The lower frame 70C is connected to the upper frame 50 by a screw. The lower frame 70C is different from a cassette pedestal unit that is optionally attached for function expansion such as increasing the number of sheets S that can be accommodated.

The lower frame 70C includes a lower rear side plate 72, a bottom plate 73, a reinforcing plate 74, another reinforcing plate 75, a beam member 515, a beam member 517, another beam member 518, a right outer strut 711, and a left outer strut 713. The beam member 515, the beam member 517, the beam member 518, the right outer strut 711, and the left outer strut 713 constitute a front frame portion provided on the front side of the lower frame 70C.

The lower rear side plate 72 as a rear frame portion is provided on the rear side of the lower frame 70C. The lower rear side plate 72 faces the beam member 515, the beam member 517, the beam member 518, the right outer strut 711, and the left outer strut 713 in the front-rear direction. The lower rear side plate 72 is fixed to the bottom plate 73, for example by welding. The upper rear side plate 52 is positioned and placed on the lower rear side plate 72. The lower rear side plate 72 is connected to the upper rear side plate 52 by a screw.

The bottom plate 73 is provided below the frame body 100a.

The reinforcing plate 74 is fixed to the left outer strut 713, the lower rear side plate 72, and the bottom plate 73 by welding.

The reinforcing plate 75 is fixed to the right outer strut 711, the lower rear side plate 72, and the bottom plate 73 by welding.

The beam member 515 (first beam) extends in the left-right direction as the first direction intersecting the vertical direction and connects the right outer strut 711 and the left outer strut 713. The beam member 515 is connected to the right outer strut 711 and the left outer strut 713 by screws. An upper front frame is positioned and placed on the beam member 515. The beam member 515 is connected to the upper front frame by a screw. The beam member 515 is connected to the right outer strut 711 and the left outer strut 713 by screws so as to be detachably connected to the right outer strut 711 and the left outer strut 713.

The beam member 517 (second beam) extends in the first direction intersecting the vertical direction and connects the right outer strut 711 and the left outer strut 713. The beam member 517 is connected to the right outer strut 711 and the left outer strut 713 by screws below the beam member 518. The beam member 517 is disposed so as to be parallel to the beam member 515. The beam member 517 is connected to the right outer strut 711 and the left outer strut 713 by screws so as to be detachably connected to the right outer strut 711 and the left outer strut 713.

The beam member 518 is connected to the right outer strut 711 and the left outer strut 713 by screws between the beam member 515 and the beam member 517. The beam member 518 is disposed so as to be parallel to the beam member 517. The beam member 518 is connected to the right outer strut 711 and the left outer strut 713 by screws so as to be detachably connected to the right outer strut 711 and the left outer strut 713.

The right outer strut 711, as a first strut, extends in the vertical direction at the left end of the lower frame 70C and is fixed to the left end of the bottom plate 73, for example by welding.

The left outer strut 713, as a second strut, extends in the vertical direction at the right end of the lower frame 70C and is fixed to the right end of the bottom plate 73, for example by welding.

In the frame body 100a having the above configuration, the right outer strut 711, the left outer strut 713, and the beam member 518 support the sheet cassette 11a, and the right outer strut 711, the left outer strut 713, and the beam member 517 support the sheet cassette 11b. The right outer strut 711, the left outer strut 713, and the bottom plate 73 support the sheet cassette 11c.

In addition, each of the spacing between the beam member 515 and the beam member 518 in the vertical direction, the spacing between the beam member 518 and the beam member 517, and the spacing between the beam member 517 and the bottom plate 73 can be changed according to the number of large-sized sheets S to be accommodated.

Next, the configuration of the frame body of the image forming apparatus A3 will be described in detail with reference to FIGS. 4 to 6 and FIGS. 8A to 13B. In FIGS. 7A to 13B, the positive direction of the X axis is the right direction, the negative direction of the X axis is the left direction, the positive direction of the Y axis is the rear direction, the negative direction of the Y axis is the front direction, the positive direction of the Z axis is the upper, vertical direction, and the negative direction of the Z axis is defined as the lower, vertical direction.

In FIGS. 8A and 8B, FIG. 8A illustrates a state in which a central stay unit 516 of the lower frame 70c of the frame body of the image forming apparatus A3 is removed, and FIG. 8B illustrates a configuration of the lower frame 70c of the frame body of the image forming apparatus A3.

In the configuration of the frame body of the image forming apparatus A3, portions having the same configuration as the frame body 100a of the image forming apparatus A1 are denoted by the same reference numerals, and description of such components is incorporated by reference, for conciseness.

The frame body of the image forming apparatus A3 supports the sheet cassette 11c, the sheet cassette 11f, and the sheet cassette 11g. The frame body of the image forming apparatus A3 includes an upper frame 50 and a lower frame 70c. A dashed-dotted line V in FIG. 3 indicates a boundary between the upper frame 50 and the lower frame 70c.

The upper frame 50 is formed of a metal steel plate, and is disposed above the lower frame 70c in the vertical direction. The upper frame 50 is connected to the lower frame 70c by a screw.

The lower frame 70c is made of a metal steel plate, and is disposed below the upper frame 50 in the vertical direction. The lower frame 70c is connected to the upper frame 50 by a screw. The lower frame 70c is different from a cassette pedestal unit that is optionally attached for function expansion such as increasing the number of sheets S that can be accommodated.

The lower frame 70c includes a lower rear side plate 72, a bottom plate 73, a reinforcing plate 74, another reinforcing plate 75, a central stay attachment portion 305, a beam member 515, a central stay unit 516, a beam member 517, a right outer strut 711, and a left outer strut 713. The beam member 515, the beam member 517, the right outer strut 711, and the left outer strut 713 constitute a front frame portion provided on the front side of the lower frame 70c.

The lower rear side plate 72 is provided on the rear side of the lower frame 70c. The lower rear side plate 72 faces the beam member 515, the beam member 517, the right outer strut 711, and the left outer strut 713 in the front-rear direction.

The bottom plate 73 is provided below the frame body of the image forming apparatus A3.

The right outer strut 711 extends in the vertical direction at the left end of the lower frame 70c and is fixed to the left end of the bottom plate 73, for example by welding.

The left outer strut 713 extends in the vertical direction at the right end of the lower frame 70c and is welded to the right end of the bottom plate 73, for example by welding.

The central stay attachment portion 305 as a fixing member is attached to the center of the beam member 517 in the left-right direction. A screw hole 305a, which is a through hole penetrating in the plate thickness direction, is formed in the central stay attachment portion 305.

The central stay unit 516 is disposed at the center of the beam member 515 and the beam member 517 in the left-right direction between the right outer strut 711 and the left outer strut 713 and between the beam member 515 and the beam member 517 in order to accommodate the small-size cassette 1000. The central stay unit 516 is connected to the beam member 515 by a screw, extends in the vertical direction from the beam member 515, and is connected to the central stay attachment portion 305 by a screw. The central stay unit 516 is detachably connected to the beam member 515 and the central stay attachment portion 305 by being connected to the beam member 515 and the central stay attachment portion 305 by screws.

The central stay unit 516 includes a slide rail 300, another slide rail 301, a rail mounting plate 302, a sheet supporting plate 303, a central stay member 304, a central stay fixing portion 400, and a strut reinforcing plate 401.

A slide rail 300 is provided to allow the small-size cassette 1000 to be drawn out. The slide rail 300 includes a slide member 300a and a slide guide member 300b. Slide for may be provided for allowing the small-size cassette 1000 or the large-size cassette 1010 to be drawn out, on the right outer strut 711 and the left outer strut 713 side.

A stepped screw 701 and a stepped screw 702 detachably engaged with a small cassette hooking portion 703 provided on the small-size cassette 1000 are attached to the slide member 300a. The slide member 300a is guided by the slide guide member 300b to be slidable in the front-rear direction together with the small-size cassette 1000.

The slide guide member 300b is connected to the sheet supporting plate 303 by a screw. The front end side of the slide guide member 300b is connected to the rail mounting plate 302 by a screw in order to increase strength against a load applied to the front end side of the slide guide member 300b.

The other slide rail 301 is provided to allow the small-size cassette 1000 to be drawn out. The other slide rail 301 includes a slide member having the same configuration as the slide member 300a, and a slide guide member 300b.

The slide member of the slide rail 301 is guided by the slide guide member 301b to be slidable in the front-rear direction together with the small-size cassette 1000.

The slide guide member 301b is connected to the sheet supporting plate 303 by a screw. The front end side of the slide guide member 301b is connected to the rail mounting plate 302 by a screw in order to increase strength against a load applied to the front end side of the slide guide member 301b.

The slide guide member 300b and the slide guide member 301b are connected to the rail mounting plate 302. The rail mounting plate 302 is formed with a through hole 500 that makes the insertion hole 401a of the strut reinforcing plate 401 and the screw hole 305a of the central stay attachment portion 305 visible from the front when the central stay unit 516 is mounted to the central stay attachment portion 305.

The sheet supporting plate 303, as a sheet supporting plate member, has a plate shape, is connected to the lower rear side plate 72 by screws, and is connected to the slide guide member 300b, the slide guide member 301b, and the rail mounting plate 302 by screws. The sheet supporting plate 303 is detachably connected to the lower rear side plate 72 by being connected to the lower rear side plate 72 by a screw.

The central stay member 304, as a stay, is connected to each of the beam member 515 and the central stay attachment portion 305 provided in the beam member 517 by screws. The central stay member 304 is detachably connected to the beam member 515 and the central stay attachment portion 305 by screws. The central stay member 304 is connected to each of the slide guide member 300b, the slide guide member 301b, and the rail mounting plate 302 by screws.

The central stay fixing portion 400 is provided on the front end portion side at the lower end of the central stay member 304. The central stay fixing portion 400 protrudes below the central stay member 304 and the strut reinforcing plate 401. The central stay fixing portion 400 is formed with an insertion hole 400a that penetrates in the plate thickness direction and through which the screw is inserted.

The strut reinforcing plates 401 are provided at the lower end and the rear end of the central stay member 304. The strut reinforcing plate 401 is formed with an insertion hole 401a that penetrates in the plate thickness direction and through which the screw is inserted.

In the central stay unit 516 having the above configuration, the slide rail 300, the other slide rail 301, the rail mounting plate 302, the sheet supporting plate 303, the central stay member 304, and the strut reinforcing plate 401 are unitized.

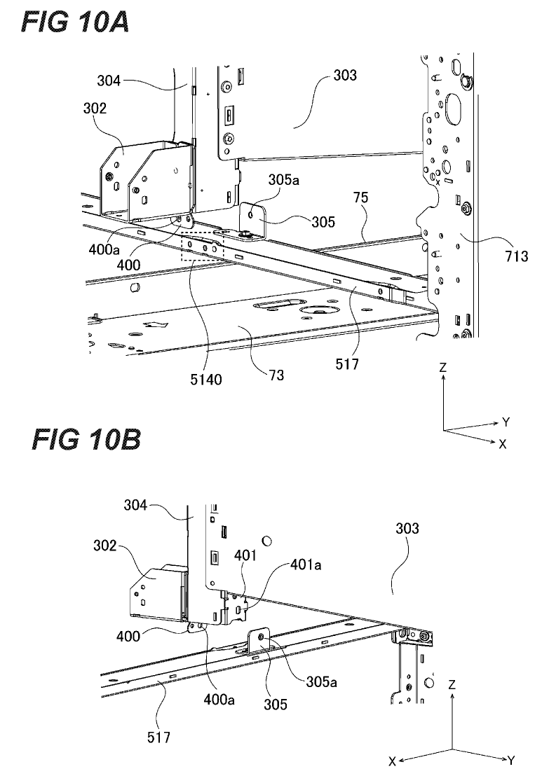

The beam member 517 includes another central stay attachment portion 5140 to which the central stay fixing portion 400 is connected by a screw at the center in the left-right direction (FIG. 10A).

In the frame body of the image forming apparatus A3, the right outer strut 711, the central stay member 304, and the beam member 517 support the sheet cassette 11f. As a result, the sheet cassette 11f as a first sheet cassette is supported on the left side as the first side of the central stay member 304 in the first direction intersecting the vertical direction.

The left outer strut 713, the central stay member 304, and the beam member 517 support the sheet cassette 11g. As a result, the sheet cassette 11g, as a second sheet cassette, is supported on the right side as the second side of the central stay member 304 in the first direction intersecting the vertical direction. Further, the right outer strut 711, the left outer strut 713, and the bottom plate 73 support the sheet cassette 11c.

In the frame body of the image forming apparatus A3, the spacing in the vertical direction between the beam member 515 and the beam member 518 can be changed according to the number of small-sized sheets S to be accommodated.

The configuration of the frame body 100b of the image forming apparatus A2 will be described in detail with reference to FIGS. 4 to 6 and FIG. 7A and 7C.

FIG. 7A is a schematic front view of the frame body 100b of the image forming apparatus A2.

In the configuration of the frame body 100b of the image forming apparatus A2, portions having the same configuration as the frame body 100a of the image forming apparatus A1 are denoted by the same reference numerals, and description of such components is incorporated by reference, for conciseness.

The frame body 100b supports the sheet cassette 11b, the sheet cassette 11c, the sheet cassette 11d, and the sheet cassette 11e. The frame body 100b includes an upper frame 50 and a lower frame. A dashed-dotted line V in FIG. 2 indicates a boundary between the upper frame 50 and the lower frame.

The upper frame 50 is formed of a metal steel plate, and is disposed above the lower frame in the vertical direction. The upper frame 50 is connected to the lower frame by a screw.

The lower frame is formed of a metal steel plate and is disposed below the upper frame 50 in the vertical direction. The lower frame is connected to the upper frame 50 by a screw. The lower frame is different from a cassette pedestal unit that is optionally attached for function expansion such as increasing the number of sheets S that can be accommodated.

The lower frame includes a lower rear side plate 72, a bottom plate 73, a reinforcing plate 74, another reinforcing plate 75, a beam member 515, a beam member 517, a beam member 518, a right outer strut 711, a left outer strut 713, and a central stay unit 516. The beam member 515, the beam member 517, the beam member 518, the right outer strut 711, and the left outer strut 713 constitute a front frame portion provided on the front side of the lower frame.

The lower rear side plate 72 is provided on the rear side of the lower frame.

The bottom plate 73 is provided below the frame body 100b.

The right outer strut 711 extends in the vertical direction at the left end of the lower frame and is fixed to the left end of the bottom plate 73, for example by welding.

The left outer strut 713 extends in the vertical direction at the right end of the lower frame and is fixed to the right end of the bottom plate 73, for example by welding.

The central stay unit 516 is disposed at the center of the beam member 515 and the beam member 518 in the left-right direction between the beam member 515 and the beam member 518 in order to accommodate the small-size cassette 1000. Other than as described above, the configuration of the central stay unit 516 is the same as the configuration of the central stay unit 516, and the detailed description and illustration thereof of such components is incorporated by reference, for conciseness.

The beam member 518 may be configured to connect to the central stay unit 516 having the same configuration as the central stay attachment portion 5140 of the beam member 517. Also, the central stay attachment portion 305 for connecting to the central stay unit 516 may be attached to the beam member 518.

In the frame body 100b having the above configuration, the right outer strut 711, the central stay member of the central stay unit 516, and the beam member 518 support the sheet cassette 11d. As a result, the sheet cassette 11d, as a first sheet cassette, is supported on the left side as the first side of the central stay member of the central stay unit 516 in the first direction intersecting the vertical direction.

The left outer strut 713, the central stay member of the central stay unit 516, and the beam member 518 support the sheet cassette 11e. As a result, the sheet cassette 11e, as a second sheet cassette, is supported on the right side as the second side of the central stay member of the central stay unit 516 in the first direction intersecting the vertical direction. The right outer strut 711, the left outer strut 713, and the beam member 517 support the sheet cassette 11b, and the right outer strut 711, the left outer strut 713, and the bottom plate 73 support the sheet cassette 11c.

### Operation of Image Forming Apparatus

The operation of the image forming apparatus A1 according to the present disclosure will be described in detail with reference to FIGS. 1 to 3.

The image forming apparatus A1 starts an operation and starts a process of forming an image when an image forming job signal is input to a controller.

First, the sheet S stored in any one of the sheet cassette 11a, the sheet cassette 11b, and the sheet cassette 11c is picked up by the pick-up roller 12a, the pick-up roller 12b, or the pick-up roller 12c.

The picked-up sheet S is fed by the pair of feed rollers 13a, the pair of feed rollers 13b, or the pair of feed rollers 13c, and is conveyed to the pair of registration rollers 15 by the pair of conveying rollers 14a.

The sheet S conveyed to the pair of registration rollers 15 is subjected to skew feeding correction by the registration roller pair 15, and then conveyed to a secondary transfer portion formed by the secondary transfer roller 7 and the secondary transfer counter roller 8 by the pair of registration rollers 15 at a predetermined timing.

In the image forming unit 10, the surfaces of the photosensitive drums 1Y, 1M, 1C, and 1K are charged by the charging rollers 2Y, 2M, 2C, and 2K.

Next, the laser scanner unit 3 irradiates the surfaces of the photosensitive drums 1Y, 1M, 1C, and 1K with laser light according to image data transmitted from an external device and received, and forms electrostatic latent images on the surfaces of the photosensitive drums 1Y, 1M, 1C, and 1K.

Next, the developing device 4Y attaches yellow toner to the electrostatic latent image formed on the surface of the photosensitive drum 1Y to form a yellow toner image on the surface of the photosensitive drum 1Y. Each of the developing devices 4M, 4C, and 4K also forms magenta, cyan, and black toner images on the surfaces of the photosensitive drums 1M, 1C, and 1K by a similar process.

The toner images formed on the surfaces of the photosensitive drums 1Y, 1M, 1C, and 1K are primarily transferred to the intermediate transfer belt 6 by a primary transfer bias current flowing through the primary transfer rollers 5Y, 5M, 5C, and 5K.

The full-color toner image primarily transferred to the intermediate transfer belt 6 is conveyed to the secondary transfer portion formed by the secondary transfer roller 7 and the secondary transfer counter roller 8 by the rotation of the intermediate transfer belt 6.

The full-color toner image conveyed to the secondary transfer portion is secondarily transferred from the intermediate transfer belt 6 to the sheet S in the secondary transfer portion by a secondary transfer bias current flowing through the secondary transfer roller 7.

The sheet S on which the toner image has been secondarily transferred is conveyed to the fixing device 9 by the pair of conveying rollers 14e.

The sheet S conveyed to the fixing device 9 is subjected to heating and pressurization in the fixing device 9, whereby the toner image is fixed.

The sheet S on which the toner image is fixed is discharged to the discharge tray 19 by the pair of discharge rollers 17.

On the other hand, in the case of forming images on both surfaces of the sheet S, the sheet S on which an image is formed on the first surface and which has passed through the fixing device 9 is conveyed to the reverse conveying portion 21 and is switchback conveyed in the reverse conveying portion 21, so that the front and back sides and leading and trailing ends are reversed.

The sheet S whose front and back sides and leading and trailing ends are reversed is conveyed to the pair of registration rollers 15 via the duplex conveying portion 22. Then, a toner image is formed on the second surface of the sheet S conveyed to the pair of registration rollers 15 again through the above-described image forming process.

Since the operation of each of the image forming apparatus A2 and the image forming apparatus A3 is substantially the same as the operation of the image forming apparatus A1, the description of such components is incorporated by reference, for conciseness.

### Method of Manufacturing Frame Body of Image Forming Apparatus

A method of manufacturing the frame body 100a of the image forming apparatus A1, the frame body 100b of the image forming apparatus A2, and the frame body of the image forming apparatus A3 according to the present disclosure will be described in detail with reference to FIGS. 4 to 12B.

FIG. 10A is a perspective view of a part of the frame body of the image forming apparatus A3, viewed from the front right upper side. FIG. 10B is a perspective view of a part of the frame body of the image forming apparatus A3, viewed from the rear right oblique direction. FIGS. 10A and 10B illustrate a state in which the slide rail 300 and the other slide rail 301 are removed, for convenience of description.

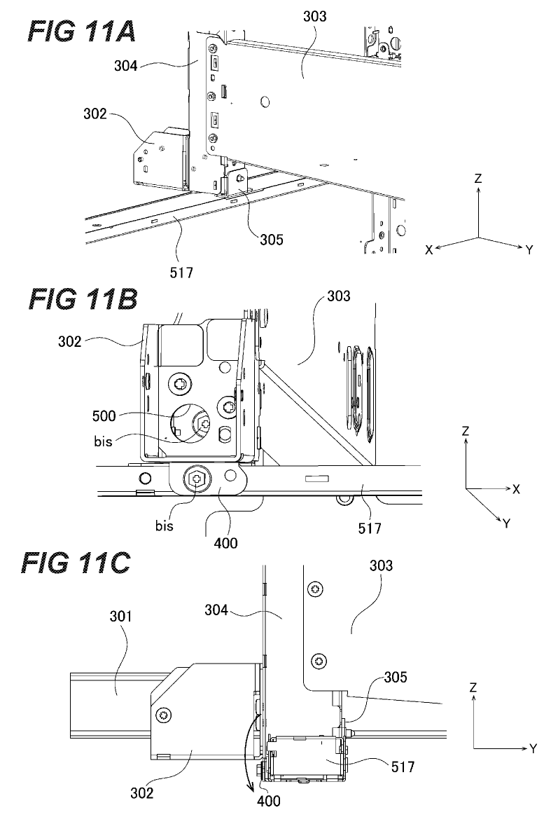

FIG. 11A is a perspective view of a part of the frame body of the image forming apparatus A3, viewed from the rear right upper side. FIG. 11B is a perspective view of a part of the frame body of the image forming apparatus A3, viewed from the front right lower side. FIG. 11C is a view of a part of the frame body of the image forming apparatus A3, viewed from the right side. FIGS. 11A, 11B, and FIG. 11C illustrate a state in which the slide rail 300 and the other slide rail 301 are removed, for convenience of description.

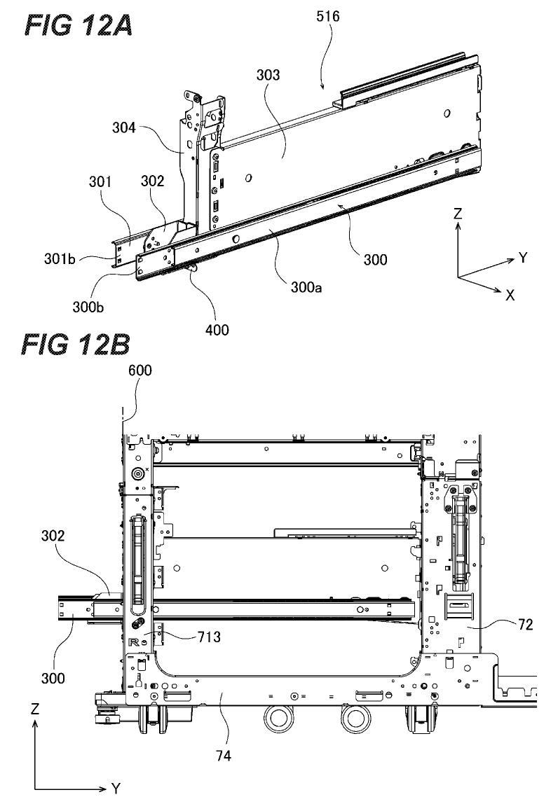

FIG. 12A is a perspective view of the central stay unit 516, viewed from the front right upper side. FIG. 12B is a view of the frame body of the image forming apparatus A3, viewed from the right side.

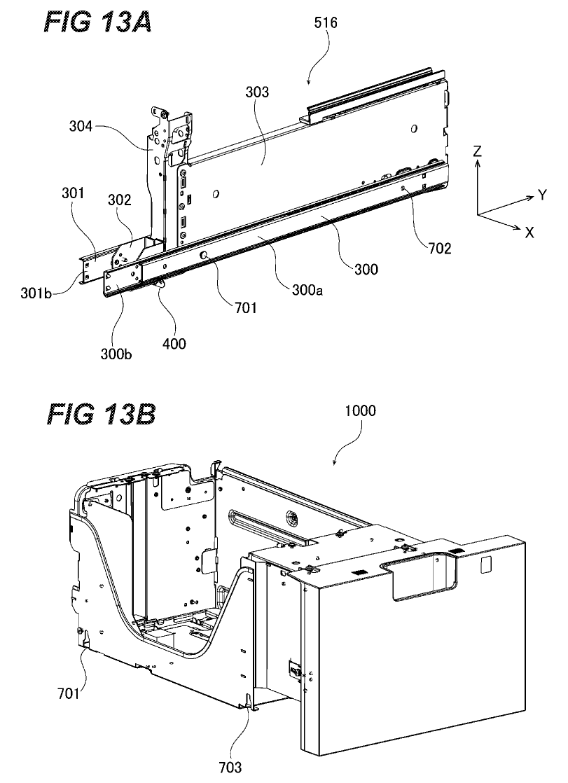

FIG. 13A is a perspective view of the central stay unit 516, viewed from the front right upper side. FIG. 13B is a perspective view of the small-size cassette 1000.

For manufacture of the upper frame 50, the stay 513, the upper right strut 511, and the upper left strut 512 are welded together. Also, the stay 514, the upper right strut 511, and the upper left strut 512 are welded together. In addition, the stay 58, the upper right strut 511, and the upper rear side plate 52 are welded together. Further, the stay 59, the upper left strut 512, and the upper rear side plate 52 are welded together, the stay 60, the stay 513, and the upper rear side plate 52 are welded together, and the stay 61, the stay 513, and the upper rear side plate 52 are welded together.

Also, the bottom plate 73 is welded to the right outer strut 711, the left outer strut 713, and the lower rear side plate 72. The reinforcing plate 74 is welded to the left outer strut 713, the lower rear side plate 72, and the bottom plate 73, and the reinforcing plate 75 is welded to the right outer strut 711, the lower rear side plate 72, and the bottom plate 73.

Next, each of the beam member 515, the beam member 517, and the beam member 518 and each of the right outer strut 711 and the left outer strut 713 are connected by screws. Thus, the lower frame 70C is completed.

Next, each of the beam member 515 and the beam member 517, and each of the right outer strut 711 and the left outer strut 713 are connected by screws.

Next, the central stay unit 516 is inserted between the beam member 515 and the beam member 517 from the front side toward the lower rear side plate 72 in a state where the central stay member 304 faces the front side and with the slide rail 300 and the other slide rail 301 facing the lower side.

Next, the central stay unit 516 and the lower rear side plate 72 are fixed by screws. In addition, the central stay fixing portion 400 and the central stay attachment portion 5140 are fixed by screws, and the strut reinforcing plate 401 and the central stay attachment portion 305 are fixed by screws. Thus, assembly of the lower frame 70c is completed.

Then, the central stay unit 516 can be connected to the lower rear side plate 72, the central stay attachment portion 305, and the central stay attachment portion 5140, without disassembling the beam member 515, the beam member 517, the right outer strut 711, and the left outer strut 713. In addition, by providing the through hole 500 in the rail mounting plate 302, the strut reinforcing plate 401 can be accessed from the front, so that the strut reinforcing plate 401 and the central stay attachment portion 305 can be connected from the front by an electric screwdriver or the like.

As described above, by coupling the central stay unit 516 to the lower rear side plate 72, improved assembly workability is achieved, compared with the case where the slide rail 300 and the other slide rail 301 are attached to the sheet supporting plate 303 and the rail mounting plate 302 in the frame body.

In addition, since the central stay unit 516 can be attached from the front, assembly workability can be improved.

In addition, in a case where the central stay member 304 is fixed only on the front side of the beam member 517, the weight of the sheet cassette is applied only on the front side with respect to the beam member 517. Thus, the beam member 517 is inclined in the arrow direction of FIG. 11C. On the other hand, the strut reinforcing plate 401 is connected to the central stay attachment portion 305 by screws, and the central stay fixing portion 400 is connected to the central stay attachment portion 5140 by screws. As a result, since the central stay member 304 is fixed to the beam member 517 on the rear side in addition to the front side, the rigidity of the beam member 517 can be improved.

Further, the central stay member 304 and the lower rear side plate 72 are connected by the sheet supporting plate 303. As a result, it is possible to prevent collapse of the beam member 515, the beam member 517, the beam member 518, the right outer strut 711, the left outer strut 713, and the lower rear side plate 72 due to the weight of paper stored in the sheet cassettes 11c, 11f, and 11g.

In this manner, the detachable central stay unit 516 is coupled to the beam member 515, the beam member 517, and the lower rear side plate 72. As a result, it is possible to provide the frame body of the image forming apparatus A3 that is compatible with products in which the arrangement of the large-size cassette 1010 and the small-size cassette 1000 of different sizes differs.

When the lower frame is manufactured, the bottom plate 73 is welded to the right outer strut 711, the left outer strut 713, and the lower rear side plate 72. The reinforcing plate 74 is welded to the left outer strut 713, the lower rear side plate 72, and the bottom plate 73, and the reinforcing plate 75 is welded to the right outer strut 711, the lower rear side plate 72, and the bottom plate 73.

Another central stay unit may be inserted between the beam member 515 and the beam member 518 from the front side toward the lower rear side plate 72. The method of attaching the additional central stay unit is the same as the method of attaching the central stay unit 516, in the method of manufacturing the lower frame 70c described above, and the description of such components is incorporated by reference, for conciseness.

In this manner, the additional detachable central stay unit is coupled to the beam member 515, the beam member 518, and the lower rear side plate 72. As a result, the frame body 100b may be provided that is compatible with products in which the arrangement of different large-size cassette 1010 and small-size cassette 1000.

The lower frame and the upper frame 50 manufactured by the above manufacturing method are connected by screws to complete the frame body 100a of the image forming apparatus A1. In addition, the lower frame and the upper frame 50 manufactured by the above manufacturing method are connected by screws to complete the frame body 100b of the image forming apparatus A2. Further, the lower frame 70c and the upper frame 50 manufactured by the above manufacturing method are connected by screws to complete the frame body of the image forming apparatus A3.

Although the central stay attachment portion 305 is a separate component, the present disclosure is not limited thereto, and a bent portion having the same shape as the central stay attachment portion 305 may be formed in the beam member 517, and the bent portion and the strut reinforcing plate 401 may be connected by screws.

### Operation of Small-Size Cassette

The operation of the small-size cassette 1000 of the image forming apparatus A2 or the image forming apparatus A3 according to the present disclosure will be described in detail with reference to FIGS. 12A to 13B.

The slide member 300a protrudes forward to increase the slide area of the small-size cassette 1000 for user to load the sheet S. At this time, since the sliding area of the small-size cassette 1000 is increased without increasing the product size, the slide rail 300 protrudes forward from the front position 600 (FIG. 12B) of the right outer strut 711.

On the other hand, by fixing the front end side of the slide guide member 300b to the rail mounting plate 302 with screws, strength may be improved against a load applied to the front end side of the slide rail 300. The other slide rail 301 is formed in a manner similar to the slide rail 300.

In addition, the small cassette hooking portion 703 of the small-size cassette 1000 are detachably engaged with the stepped screw 701 and the stepped screw 702 of the slide rail 300. Thus, the small-size cassette 1000 can be attached to and detached from the frame body 100b or the frame body of the image forming apparatus A3.

### Method of Reusing Frame Body of Image Forming Apparatus

A method of reusing the frame body 100a of the image forming apparatus A1, the frame body 100b of the image forming apparatus A2, and the frame body of the image forming apparatus A3 according to the present disclosure will be described in detail with reference to FIGS. 4 to 12B.

When the frame body 100a of the image forming apparatus A1 is reused as the frame body 100b of the image forming apparatus A2, the central stay unit is inserted between the beam member 515 and the beam member 518 of the frame body 100a from the front. The central stay unit, the beam member 515, and the beam member 518 are connected by screws.

In this manner, the central stay unit can be connected to the beam member 515 and the beam member 518 without disassembling the beam member 515, the beam member 517, the beam member 518, the right outer strut 711, and the left outer strut 713. As a result, the frame body 100a of the image forming apparatus A1 can be reused as the frame body 100b of the image forming apparatus A2.

When the frame body 100b of the image forming apparatus A2 is reused as the frame body 100a of the image forming apparatus A1, screws connecting the central stay unit of the frame body 100b to the beam member 515 and the beam member 518 are removed to remove the central stay unit.

In this manner, the central stay unit can be removed with respect to the beam member 515 and the beam member 518 without disassembling the beam member 515, the beam member 517, the beam member 518, the right outer strut 711, and the left outer strut 713. As a result, the frame body 100b of the image forming apparatus A2 can be reused as the frame body 100a of the image forming apparatus A1.

When the frame body 100a of the image forming apparatus A1 is reused as the frame body of the image forming apparatus A3, the beam member 518 is removed by removing screws connecting the beam member 518 of the frame body 100a to the right outer strut 711 and the left outer strut 713. The central stay unit 516 is inserted between the beam member 515 and the beam member 517 from the front side, and the central stay unit 516, the beam member 515, and the beam member 517 are connected by screws.

In this manner, the central stay unit 516 can be connected to the beam member 515 and the beam member 517 without disassembling the beam member 515, the beam member 517, the right outer strut 711, and the left outer strut 713. As a result, the frame body 100a of the image forming apparatus A1 can be reused as the frame body of the image forming apparatus A3.

When the frame body of the image forming apparatus A3 is reused as the frame body 100a of the image forming apparatus A1, the screws connecting the central stay unit 516 of the frame body of the image forming apparatus A3, the beam member 515, and the beam member 517 are removed, and the central stay unit 516 is removed. Between the beam member 515 and the beam member 517, the beam member 518 is connected to each of the right outer strut 711 and the left outer strut 713 by screws.

In this manner, the central stay unit can be removed with respect to the beam member 515 and the beam member 517 without disassembling the beam member 515, the beam member 517, the right outer strut 711, and the left outer strut 713. As a result, the frame body of the image forming apparatus A3 can be reused as the frame body 100a of the image forming apparatus A1.

When the frame body 100b of the image forming apparatus A2 is reused as the frame body of the image forming apparatus A3, the central stay unit 516 is removed by removing screws connecting the central stay unit 516, the beam member 515, and the beam member 518 of the frame body 100b. Next, the beam member 518 is removed by removing screws connecting the beam member 518 of the frame body 100b to the right outer strut 711 and the left outer strut 713. Then, the central stay unit 516 is inserted between the beam member 515 and the beam member 517 from the front side, and the central stay unit 516, the beam member 515, and the beam member 517 are connected by screws.

In this manner, the central stay unit 516 can be connected to the beam member 515 and the beam member 517 without disassembling the beam member 515, the beam member 517, the right outer strut 711, and the left outer strut 713. As a result, the frame body 100b of the image forming apparatus A2 can be reused as the frame body of the image forming apparatus A3.

When the frame body of the image forming apparatus A3 is reused as the frame body 100b of the image forming apparatus A2, the central stay unit 516 is removed by removing screws connecting the central stay unit 516, the beam member 515, and the beam member 517 of the frame body of the image forming apparatus A3. Then, the central stay unit is inserted between the beam member 515 and the beam member 518 from the front side, and the central stay unit, the beam member 515, and the beam member 518 are connected by screws.

In this manner, the central stay unit can be connected to the beam member 515 and the beam member 518 without disassembling the beam member 515, the beam member 517, the right outer strut 711, and the left outer strut 713. As a result, the frame body of the image forming apparatus A3 can be reused as the frame body 100b of the image forming apparatus A2.

As described above, any one of the frame body 100a of the image forming apparatus A1, the frame body 100b of the image forming apparatus A2, and the frame body of the image forming apparatus A3 can be reused for the other two, so that an environmentally friendly product can be provided.

In the present embodiment, the central stay member 304 connected to the beam member 515 and the beam member 517 and extending in the vertical direction is provided between the right outer strut 711 and the left outer strut 713. The central stay member 304 can be connected to the beam member 515 and the beam member 517 without disassembling the beam member 515, the beam member 517, the right outer strut 711, and the left outer strut 713. As a result, it is possible to perform manufacturing management and for reuse, thereby being environmentally friendly.

The present disclosure is not limited to the above embodiments, and various modifications can be made without departing from the scope of the present disclosure.

For example, in the above embodiment, the sheet supporting plate 303 is provided, but the present disclosure is not limited thereto, and the sheet supporting plate 303 may not be provided. In this case, the slide rail 300 and the slide rail 301 are connected to the lower rear side plate 72 by screws.

In the above embodiment, the central stay member 304 and the central stay member of the central stay unit are provided at the center of the beam member 515 and the beam member 517 in the left-right direction. However, the present disclosure is not limited thereto, and the central stay member 304 and the central stay member of the central stay unit may be provided on the left side or the right side with respect to the center in the left-right direction of the beam member 515 and the beam member 517 according to the size in the left-right direction of the sheet cassette.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-008705, filed January 21, 2025, which is hereby incorporated by reference herein in its entirety.

What is claimed is:

1. An image forming apparatus comprising:
a plurality of sheet cassettes, each sheet cassette of the plurality of sheet cassettes configured to store at least one sheet; and
a frame body configured to support the plurality of sheet cassettes,
wherein the frame body includes:
a front frame portion including a first strut extending in a vertical direction, a second strut extending in the vertical direction, a first beam extending in a first direction intersecting the vertical direction and connecting the first strut and the second strut, and a second beam extending in the first direction and connecting the first strut and the second strut, and
a stay connected to the first beam and the second beam, extending in the vertical direction between the first strut and the second strut,
wherein the plurality of sheet cassettes includes:
a first sheet cassette supported on a first side of the stay in the first direction, and
a second sheet cassette supported on a second side of the stay in the first direction, and
wherein the stay is detachable from the first beam and the second beam, without disassembling the front frame portion.

2. The image forming apparatus according to claim 1, wherein
the stay is connectable to and detachable from the front side of the first beam and the second beam.

3. The image forming apparatus according to claim 1, further comprising:
a rear frame portion facing the front frame portion; and
a sheet supporting plate provided between the stay and the rear frame portion.

4. The image forming apparatus according to claim 3, wherein
the sheet supporting plate is plate-shaped.

5. The image forming apparatus according to claim 3, wherein
the stay and the sheet supporting plate are unitized.

6. The image forming apparatus according to claim 1, wherein
the stay is fixed to the second beam from the front side and the rear side.

7. The image forming apparatus according to claim 1, further comprising
a fixing member configured to fix the stay and the second beam.

8. The image forming apparatus according to claim 1, further comprising:
a feeding unit that is supported by the frame body and is configured to feed a sheet stored in the sheet cassette; and
an image forming unit that is supported by the frame body and is configured to form an image on the sheet fed by the feeding unit.
